(19) United States
(12) Patent Application Publication
(10) Pub. No.: US 2017/0008439 A1
(43) Pub. Date: Jan. 12, 2017

(54) Pizza Delivery Container Leveling and Position Retaining Apparatus

(71) Applicant: Giuseppe DiFiore, Schnecksville, PA (US)

(72) Inventor: Giuseppe DiFiore, Schnecksville, PA (US)

(21) Appl. No.: 14/796,393

(22) Filed: Jul. 10, 2015

(51) Int. Cl. B60N 3/10; B60R 11/00; A47J 47/14

(52) U.S. Cl. CPC B60N 3/103; A47J 47/14; B60R 11/00; B60R 2011/0012; B60R 2011/005

(57) ABSTRACT

A pizza delivery container leveling and position retaining structure having outwardly and upwardly angled walls from a centrally located platform form a bounded location for retaining a pizza delivery container therein. A rear downwardly extending support and upwardly angled foot extend along the rear of the platform resting on the rear of a vehicle seat at the junction with the seat back forming a capture point for engaging the seat belt to secure the structure in place. The platform also rests against the front portion of the seat crating a stable, level place for transporting a pizza delivery container.

### BACKGROUND OF THE INVENTION

For more than several decades pizza has been delivered to people's homes via a large flat box that is either directly laid on top of the front seat next to the delivery driver, or placed in a heat retaining container and laid on the seat next to the delivery driver or on the back seat of the vehicle. In any of these cases the incline of the seat portion of the vehicle seat, that is higher in the front and lower at the upright back support, allows the pizza to slide to the portion of the pizza delivery box that is closest to the seat back. This active sliding can cause crushing of the dough and toppings, spilling of the toppings over the side of the pizza, or other spoilage of the foodstuff. Further, in the event of a sudden stop, the pizza box that is not retained by any means on the vehicle seat will slide forward usually ending up on the floor of the delivery vehicle also causing any of the above listed distresses to the foodstuff.

The present invention seeks to provide a stable, level platform for the pizza delivery box where such platform is held in position by a vehicle seat belt so as not to slide sideways or toward the front of the vehicle seat. Further, the present invention also seeks to retain the pizza delivery box in a limited or restricted space so that the box, and the pizza inside, does not slide around on the seat or slide off the stable, level platform preserving the foodstuff so that it is appetizing for the purchaser upon delivery.

Other objects will appear hereinafter.

### SUMMARY OF THE INVENTION

A pizza delivery container leveling and position retaining structure is described as follows. The structure includes a flat bottom platform having upstanding sidewalls angled slightly outward along substantially the entirety of both sides of the platform for supporting a pizza delivery container. A front wall is also angled slightly outward along substantially the entire front of the platform with the front wall extending upward a distance greater than the two sidewalls. A support extends downward from the rear of the platform at an angle that is substantially perpendicular to the plane of the platform. The support extends along substantially the entire rear of the platform and has at its distal end a foot portion that extends the same distance along the rear of the platform and forward at an upward angle toward the platform for partially supporting the platform by resting on a vehicle seat. The structure is also supported by the platform resting directly on the vehicle seat at a point closer to the front of the seat. The downwardly extending support and the foot portion create at their juncture a capture point for a vehicle seat belt to be inserted and extend along the support and foot at the rear of the structure to retain the overall structure against the vehicle seat and seat back junction. The structure as described is then able to remain level and secure in a position atop the vehicle seat and against the seat back so that the pizza delivery container will be contained within the walls of the structure and the vehicle seat back to prevent the pizza delivery container from sliding forward or side to side causing damage or distress to the foodstuffs contained in the container.

The structure may be manufactured from a suitable light weight rigid polymer composition or other composite material that will retain its shape and withstand the rigors of use by delivery people. Further, the polymer composition or other composite material of the structure may be transparent, translucent or opaque. The transparent or opaque structure may be manufactured in any color.

### BRIEF DESCRIPTION OF THE DRAWINGS

For the purpose of illustrating the invention, there is shown in the drawings forms which are presently preferred; it being understood, however, that the invention is not limited to the precise arrangements and instrumentalities shown.

FIG. 1 is an isometric view of the pizza delivery container leveling and retention apparatus of the present invention with the pizza delivery box shown in dashed lines and the vehicle seat in phantom.

FIG. 2 is a side view of the pizza delivery container leveling and retention apparatus of the present invention with the pizza delivery box in place and the leveling and retention apparatus secured in position on a vehicle seat.

### DETAILED DESCRIPTION OF THE PREFERRED EMBODIMENTS

The following detailed description is of the best presently contemplated mode of carrying out the invention. The description is not intended in a limiting sense, and is made solely for the purpose of illustrating the general principles of the invention. The various features and advantages of the present invention may be more readily understood with reference to the following detailed description taken in conjunction with the accompanying drawings.

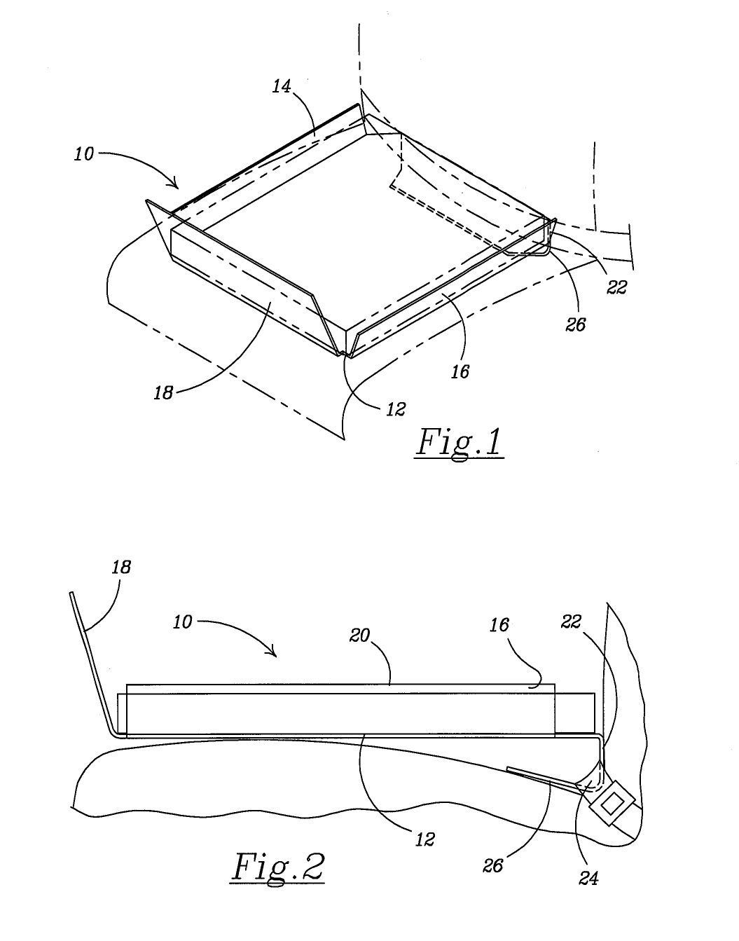

Referring now to the drawings in detail, where like numerals refer to like parts or elements, there is shown in FIG. 1 the pizza delivery container leveling and retention device 10 of the present invention. The vehicle seat for supporting the leveling and retention device 10 is shown in phantom lines with both a sitting portion beneath the leveling and retention device 10 and the seat back behind. Also shown in phantom is the vehicle seat belt that extends across the seat back capturing the leveling and retention device 10 as described more fully below.

The pizza delivery container leveling and retention device 10 has a flat bottom platform 12 having an underside that contacts the top side of the vehicle seat as shown in FIG. 2. The flat bottom platform 12 is dimensioned to accommodate a pizza delivery container of any standard size, and is large enough to accommodate a pizza delivery bag for keeping the pizza warm as well. The flat bottom platform 12 has like sidewalls 14, 16 that extend upward from the platform at a slightly outward angle for retaining the pizza delivery box 20 within the sidewalls and preventing the box 20 from sliding from side to side along the vehicle seat. Along the front of the platform 12 is a front wall 18 that extends upward a distance greater than the sidewalls 14, 16 to retain the pizza delivery box 20 in position on the platform 12 and prevent the box 20 from sliding forward and falling onto the vehicle floor. The front wall 18 is also angled outward and has a height of at least twice the height of the sidewalls 14, 16 which are slightly higher than the sidewall vertical dimension of the pizza delivery box 20. The sidewalls 14, 16 and the front wall 18 are angled slightly outward to enable easier access for removing the pizza delivery box 20 from the pizza delivery container leveling and retention device 10.

In order to retain the platform 12 in a substantially level position, a substantially perpendicular support 22 is attached along the rear of the flat bottom platform 12 extending downward toward the junction of the upright seat back and the inclined seat. The downward extension support 22 extends along the entire width of the platform 12 and has a foot portion 26 that also extends the entire width of the platform 12 and rests against the vehicle seat. The foot portion 26 of the support 22 is angled back toward the bottom of platform 12 to accommodate and substantially match the upward incline at the rear of the vehicle seat in order to maintain the platform 12 in a substantially level position with respect to the vehicle floor and parallel to the ground outside the vehicle. The platform 12 is the other contact of the device 10 as it rests directly atop the vehicle seat towards the front of the inclined portion of the seat creating a stable positional relationship between the platform 12 and the downward extension support 22 and foot 26.

The downward extension support 22 and its foot portion 26 combine to provide a capture point 24 for the vehicle seatbelt that will retain the pizza delivery container leveling and retention device 10 in a fixed position atop the vehicle seat and against the seat back when the vehicle seat belt is engaged. This retaining of the pizza delivery container leveling and retention device 10 against the vehicle seat back negates any requirement for a rear wall for the platform 12 as the seat back eliminates any rearward movement of the pizza delivery box 20 when the device 10 is positioned properly against the vehicle seat back.

Placing the pizza delivery container leveling and retention device 10 in a vehicle requires nothing more than positioning the device 10 on top of a vehicle seat and against the seat back and securing the device 10 in position by engaging the seat belt with the capture point 24 between the downward extension support 22 and foot portion 26. Removing the pizza delivery container leveling and retention device 10 is just as simple by disengaging the seat belt and removing the device 10 from atop the vehicle seat.

The pizza delivery container leveling and retention device 10 can be made from any suitable light weight rigid polymer composition or other composite material that will retain its shape and withstand the rigors of use by delivery people. The polymer composition or composite material of the device 10 may be transparent, translucent or opaque, and if translucent or opaque, may be manufactured in any color. The device 10 can retain a pizza warming bag with multiple pizzas contained therein in the same fashion as a single pizza delivery box 20 without sliding or damage or distress to the foodstuff.

The present invention may be embodied in other specific forms without departing from the spirit or essential attributes thereof and, accordingly, the described embodiments are to be considered in all respects as being illustrative and not restrictive, with the scope of the invention being indicated by the appended claims, rather than the foregoing detailed description, as indicating the scope of the invention as well as all modifications which may fall within a range of equivalency which are also intended to be embraced therein.

1. A pizza delivery container leveling and position retaining structure comprising:
a flat bottom platform having upstanding sidewalls angled slightly outward along substantially the entirety of both sides of the platform for supporting a pizza delivery container;
a front wall angled slightly outward along substantially the entire front of the platform, said front wall extending upward a distance greater than the two sidewalls;
a support extends downward from the rear of the platform at an angle that is substantially perpendicular to the plane of the platform, said support extends along substantially the entire rear of the platform and has at its distal end a foot portion that extends the same distance along the rear of the platform and forward at an upward angle toward the platform for resting on a vehicle seat at the junction with the upright seat back;
said downwardly extending support and said foot portion at their juncture form a capture point for a vehicle seat belt to be inserted and extend along the entire support to retain the overall structure against the vehicle seat and seat back junction,
whereby the structure is maintained level and secure in a position atop the vehicle seat and against the seat back and the pizza delivery container will be contained within the walls of the structure and the vehicle seat back to prevent the pizza delivery container from sliding forward or side to side causing damage or distress to the foodstuffs contained therein.

2. The structure of claim 1, wherein the structure is manufactured from a suitable light weight rigid polymer composition or other composite material that will retain its shape and withstand the rigors of use by delivery people.

3. The structure of claim 1, wherein the polymer composition or other composite material of the structure may be transparent, translucent or opaque.

4. The structure of claim 3, wherein the transparent or opaque structure may be manufactured in any color.
